(19) United States
(12) Patent Application Publication
(10) Pub. No.: US 2004/0081386 A1
(43) Pub. Date: Apr. 29, 2004

(54) Method and apparatus for modulating an optical beam with a ring resonator having a charge modulated region

(76) Inventors: Michael T. Morse, San Jose, CA (US); William R. Headley, Santa Clara, CA (US); Mario J. Paniccia, Santa Clara, CA (US)

Correspondence Address: James Y. Go, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/280,397

(22) Filed: Oct. 25, 2002

(51) Int. Cl. G02B 6/26; G02F 1/035

(52) U.S. Cl. 385/15; 385/50; 385/3

(57) ABSTRACT

An apparatus and method for modulating an optical beam by modulating charge in ring resonator to modulate a resonance condition of the ring resonator. In one embodiment, an apparatus according to embodiments of the present invention includes a ring resonator having a resonance condition disposed in semiconductor material. An input optical waveguide disposed in the semiconductor material is optically coupled to the ring resonator. An output optical waveguide is disposed in the semiconductor material and is optically coupled to the ring resonator. A charge modulated region is disposed in the ring resonator and the charge modulated region is adapted to be modulated to adjust a resonance condition of the ring resonator.

### BACKGROUND OF THE INVENTION

1. Field of the Invention

The present invention relates generally to optics and, more specifically, the present invention relates to modulating optical beams.

2. Background Information

The need for fast and efficient optical-based technologies is increasing as Internet data traffic growth rate is overtaking voice traffic pushing the need for optical communications. Transmission of multiple optical channels over the same fiber in the dense wavelength-division multiplexing (DWDM) systems and Gigabit (GB) Ethernet systems provide a simple way to use the unprecedented capacity (signal bandwidth) offered by fiber optics. Commonly used optical components in the system include wavelength division multiplexed (WDM) transmitters and receivers, optical filter such as diffraction gratings, thin-film filters, fiber Bragg gratings, arrayed-waveguide gratings, optical add/drop multiplexers, lasers and optical switches. Optical switches may be used to modulate optical beams. Two commonly found types of optical switches are mechanical switching devices and electro-optic switching devices.

Mechanical switching devices generally involve physical components that are placed in the optical paths between optical fibers. These components are moved to cause switching action. Micro-electronic mechanical systems (MEMS) have recently been used for miniature mechanical switches. MEMS are popular because they are silicon based and are processed using somewhat conventional silicon processing technologies. However, since MEMS technology generally relies upon the actual mechanical movement of physical parts or components, MEMS are generally limited to slower speed optical applications, such as for example applications having response times on the order of milliseconds.

In electro-optic switching devices, voltages are applied to selected parts of a device to create electric fields within the device. The electric fields change the optical properties of selected materials within the device and the electro-optic effect results in switching action. Electro-optic devices typically utilize electro-optical materials that combine optical transparency with voltage-variable optical behavior. One typical type of single crystal electro-optical material used in electro-optic switching devices is lithium niobate (LiNbO₃).

Lithium niobate is a transparent, material that exhibits electro-optic properties such as the Pockels effect. The Pockels effect is the optical phenomenon in which the refractive index of a medium, such as lithium niobate, varies with an applied electric field. The varied refractive index of the lithium niobate may be used to provide switching. The applied electrical field is provided to present day electro-optical switches by external control circuitry.

Although the switching speeds of these types of devices are very fast, for example on the order of nanoseconds, one disadvantage with present day electro-optic switching devices is that these devices generally require relatively high voltages in order to switch optical beams. Consequently, the external circuits utilized to control present day electro-optical switches are usually specially fabricated to generate the high voltages and suffer from large amounts of power consumption. In addition, integration of these external high voltage control circuits with present day electro-optical switches is becoming an increasingly challenging task as device dimensions continue to scale down and circuit densities continue to increase.

### BRIEF DESCRIPTION OF THE DRAWINGS

The present invention is illustrated by way of example and not limitation in the accompanying figures.

FIG. 1 is a diagram illustrating one embodiment of an optical device including a ring resonator and a plurality of waveguides in semiconductor material in accordance with the teachings of the present invention.

FIG. 2 is a cross-section illustration of one embodiment of a ring resonator in an optical device including a rib waveguide with a charge modulated region disposed in semiconductor in accordance with the teachings of the present invention.

FIG. 3 is a diagram illustrating optical throughput or transmission power in relation to resonance condition or phase shift an optical beam through an the optical device in accordance with the teachings of the present invention.

FIG. 4 is a cross-section illustration of another embodiment of a ring resonator in an optical device including a rib waveguide with a charge modulated region disposed in semiconductor in accordance with the teachings of the present invention.

FIG. 5 is a cross-section illustration of one embodiment of a ring resonator in an optical device including a strip waveguide with a charge modulated region disposed in semiconductor in accordance with the teachings of the present invention.

FIG. 6 is a diagram illustrating one embodiment of an optical device including a plurality of ring resonators and a plurality of waveguides in semiconductor material in accordance with the teachings of the present invention.

FIG. 7 is a block diagram illustration of one embodiment of a system including an optical transmitter and an optical receive with an optical device according to embodiments of the present invention to modulate an optical beam directed from the optical transmitter to the optical receiver.

### DETAILED DESCRIPTION

Methods and apparatuses for modulating an optical beam in an optical device are disclosed. In the following description numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments. In addition, it is appreciated that the figures provided herewith are for explanation purposes to persons ordinarily skilled in the art and that the drawings are not necessarily drawn to scale.

In one embodiment of the present invention, a semiconductor-based optical device is provided in a fully integrated solution on a single integrated circuit chip. One embodiment of the presently described optical device includes semiconductor-based optical waveguides optically coupled to a ring resonator. An optical beam is directed through a first waveguide. A wavelength of the optical beam matching a resonance condition of the ring resonator is optically coupled into the ring resonator. That wavelength of the optical beam is then optically coupled to a second waveguide and is output from the optical device. In one embodiment, the ring resonator includes a charge region that is modulated in response to a signal. For instance, in one embodiment, the ring resonator includes a capacitor-type of structure in which charge is modulated to adjust an optical path length or resonance condition of the ring resonator. It is appreciated that other suitable types of structures could be implemented in accordance with the teachings of the present invention to modulate the charge region in the ring resonator such as for example reverse-biased PN structures or the like to modulate charge in the ring resonator to adjust the resonance condition. Other embodiments might include for example current injection structures or other suitable structures to modulate charge in the ring resonator to adjust the resonance condition. By adjusting the resonance condition of the ring resonator with the charge modulated region, the optical beam that is coupled into the second waveguide and output from the optical device is modulated in response to the signal in accordance with the teachings of the present invention.

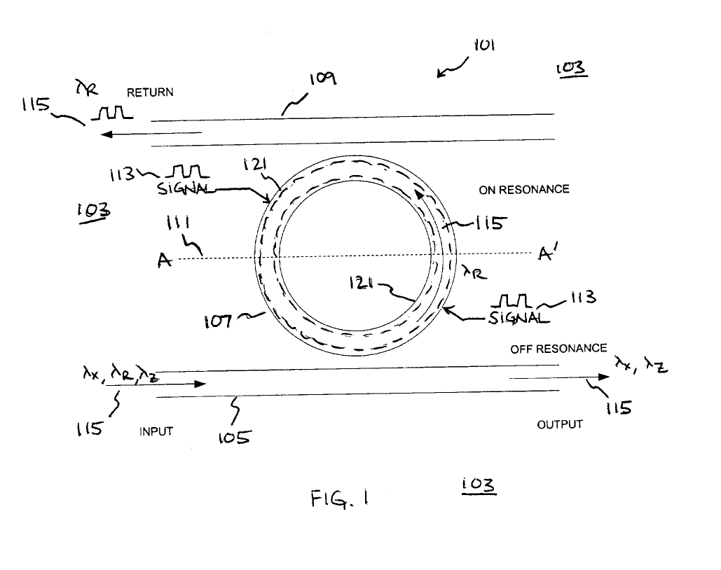

To illustrate, FIG. 1 is a diagram illustrating generally one embodiment of an optical device 101 in accordance with the teachings of the present invention. In one embodiment, optical device 101 includes a ring resonator waveguide 107 having a resonance condition disposed in semiconductor material 103. An input optical waveguide 105 is disposed in the semiconductor material 103 and is optically coupled to ring resonator waveguide 107. An output optical waveguide 109 is disposed in the semiconductor material 103 and is optically coupled to ring resonator waveguide 107. In one embodiment, a charge modulated region 121 is modulated within ring resonator waveguide 107 in response to a signal 113, which results in the resonance condition of ring resonator waveguide 107 being adjusted in response to signal 115.

Operation according to one embodiment is as follows. An optical beam 115, including a wavelength λ_{R}, is directed into an input port of optical waveguide 105, which is illustrated at the bottom left of FIG. 1. Optical beam 115 travels through optical waveguide 105 until it reaches ring resonator waveguide 107. If the resonance condition of ring resonator waveguide 107 matches the wavelength λ_{R}, the wavelength λ_{R} portion of optical beam 115 is evanescently coupled into ring resonator waveguide 107. The wavelength λ_{R} portion of optical beam 115 travels through ring resonator waveguide 107 and is evanescently coupled into waveguide 109. The wavelength λ_{R} portion of optical beam 115 then travels through waveguide 109 and out of the return port of waveguide 109, which is illustrated at the top left of FIG. 1. If the ring resonator waveguide 107 is not in resonance with particular wavelengths (e.g. λ_{X} or λ_{Z}) of optical beam 115, those wavelengths of optical beam 115 continue through waveguide 105 past ring resonator waveguide 107 and out of the output port of waveguide 109, which is illustrated at the bottom right of FIG. 1.

In one embodiment of the present invention, the optical path length of ring resonator waveguide 107 is adjusted by modulating the resonance condition of ring resonator waveguide 107. In one embodiment, the resonance condition is altered by modulating free charge carriers in a charge modulated region 121 within ring resonator waveguide 107 in response to a signal 113. By altering the resonance condition of ring resonator waveguide 107, the λ_{R} wavelength of optical beam 115 output from the return port of waveguide 109 is modulated in accordance with the teachings of the present invention. In one embodiment, ring resonator waveguide 107 is designed such that charge modulated region 121 has the ability to strongly alter the optical path length of ring resonator waveguide 107. In addition, one embodiment of ring resonator waveguide 107 features a substantially large resonance or large Q factor to help provide a substantially effective extinction ratio.

In one embodiment, ring resonator waveguide 107 is one of a plurality of ring resonator waveguides disposed in semiconductor material 103 and optically coupled between waveguides 105 and 109 to modulate the λ_{R} wavelength of optical beam 115. By having more than one ring resonator waveguide for the same λ_{R} wavelength of optical beam 115, an improved Q and extinction ratio may be realized in accordance with the teachings of the present invention. In this embodiment, each of the ring resonator waveguides in semiconductor material 103 has a resonance condition that is modulated by modulating free charge carriers in respective charge modulated regions within each ring resonator waveguide. The trade-off is a sharper image in exchange for lower output power if optical coupling not ideal.

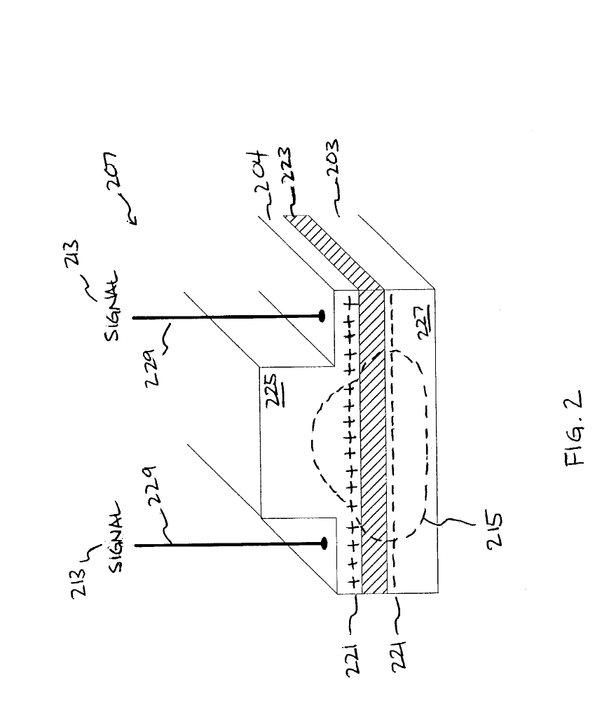

FIG. 2 is a cross-section illustration of one embodiment of a ring resonator waveguide 207 along dashed line A-A′ 111 in FIG. 1. It is appreciated that ring resonator waveguide 207 may correspond to ring resonator waveguide 107 of FIG. 1. As shown in FIG. 2, one embodiment of ring resonator waveguide 207 is a rib waveguide including an insulator layer 223 disposed between two layers 203 and 204 of semiconductor material.

In the illustrated embodiment, a signal 213 is applied to semiconductor material layer 204 through conductors 229. As illustrated in FIG. 2, in one embodiment, conductors 229 are coupled to semiconductor material layer 204 in the “upper corners” of the slab region 227 of the rib waveguide outside the optical path of optical beam 215. Assuming that semiconductor material layer 204 includes p-type doping and that semiconductor material layer 203 includes n-type doping and that ring resonator waveguide 207 operates in accumulation mode, positive and negative charge carriers of modulated charge regions 221 are swept into regions proximate to insulator layer 223 as shown.

It is appreciated of course that the doping polarities and concentrations of the semiconductor material layers 203 and 204 can be modified or adjusted and/or that ring resonator waveguide 207 can operate in other modes (e.g. inversion or depletion) in accordance with the teachings of the present invention. In addition, it is appreciated that varying ranges of voltage values may be utilized for signal 213 across conductors 229 so as to realize modulated charge regions 221 proximate to insulator layer 223 in accordance with the teachings of the present invention.

The cross-section of ring resonator waveguide 207 in FIG. 2 shows the intensity profile of optical beam 215 as it is directed through ring resonator waveguide 207. In one embodiment, optical beam 215 includes infrared or near infrared light including wavelengths centered around 1310 or 1550 nanometers of the like. It is appreciated that optical beam 215 may include other wavelengths in the electromagnetic spectrum in accordance with the teachings of the present invention.

As mentioned previously, one embodiment of ring resonator waveguide 207 is a rib waveguide including a rib region 225 and a slab region 227. In the depicted embodiment, insulator layer 223 is disposed in the slab region 27 of ring resonator waveguide 207. The embodiment of FIG. 2 also shows that the intensity distribution of optical beam 215 is such that a portion of the optical beam 215 propagates through a portion of rib region 225 towards the interior of ring resonator waveguide 207 and that another portion of optical beam 215 propagates through a portion of slab region 227 towards the interior of ring resonator waveguide 207. In addition, the intensity of the propagating optical mode of optical beam 215 is vanishingly small at the “upper corners” of rib region 225 as well as the “sides” of slab region 227.

In one embodiment, the semiconductor material layers 203 and 204 include silicon, polysilicon or another suitable semiconductor material that is at least partially transparent to optical beam 215. For example, it is appreciated that in other embodiments the semiconductor material layers 203 and 204 may include a III-V semiconductor material such as for example GaAs or the like. In one embodiment, the insulator layer 223 includes an oxide material such as for example silicon oxide or another suitable material.

In one embodiment, each of the semiconductor material layers 203 and 204 are biased in response to signal 213 voltages to modulate the concentration of free charge carriers in modulated charge regions 221. As shown in FIG. 2, optical beam 215 is directed through ring resonator waveguide 207 such that optical beam 215 is directed through the modulated charge regions 221. As a result of the modulated charge concentration in modulated charge regions 221, the phase of optical beam 215 is modulated in response to the modulated charge regions 221 and/or signal 213.

In one embodiment, semiconductor material layers 203 and 204 are doped to include free charge carriers such as for example electrons, holes or a combination thereof. In one embodiment, the free charge carriers attenuate optical beam 215 when passing through modulated charge regions 215. In particular, the free charge carriers of modulated charge regions 215 attenuate optical beam 215 by converting some of the energy of optical beam 215 into free charge carrier energy.

In one embodiment, the phase of optical beam 215 that passes through modulated charge regions 215 is modulated in response to signal 213. In one embodiment, the phase of optical beam 215 passing through free charge carriers of modulated charge regions 215 is modulated due to the plasma optical effect. The plasma optical effect arises due to an interaction between the optical electric field vector and free charge carriers that may be present along the optical path of the optical beam 215. The electric field of the optical beam 215 polarizes the free charge carriers and this effectively perturbs the local dielectric constant of the medium. This in turn leads to a perturbation of the propagation velocity of the optical wave and hence the index of refraction for the light, since the index of refraction is simply the ratio of the speed of the light in vacuum to that in the medium. Therefore, the index of refraction in ring resonator waveguide 207 is modulated in response to the modulated charge regions 215. The modulated index of refraction in ring resonator waveguide 207 correspondingly modulates the phase of optical beam 215 propagating through ring resonator waveguide 207. In addition, the free charge carriers are accelerated by the field and lead to absorption of the optical field as optical energy is used up. Generally the refractive index perturbation is a complex number with the real part being that part which causes the velocity change and the imaginary part being related to the free charge carrier absorption. The amount of phase shift φ is given by

φ=(2π/λ)ΔnL (Equation 1)

with the optical wavelength λ, the refractive index change Δn and the interaction length L. In the case of the plasma optical effect in silicon, the refractive index change Δn due to the electron (ΔNₑ) and hole (ΔNₕ) concentration change is given by:

$$Δ n = \frac{{e}^{2} {λ}^{2}}{8 {π}^{2} {c}^{2} {ϵ}_{0} {n}_{0}} ( \frac{{{b}_{e} ( Δ {N}_{e} )}^{1.05}}{{m}_{e}^{*}} + \frac{{{b}_{h} ( Δ {N}_{h} )}^{0.8}}{{m}_{h}^{*}} ) \qquad ( Equation 2 )$$

where nₒ is the nominal index of refraction for silicon, e is the electronic charge, c is the speed of light, ε₀ is the permittivity of free space, mₑ* and mₕ* are the electron and hole effective masses, respectively, bₑ and bₕ are fitting parameters. The amount of charge introduced into the optical path of optical beam 215 increases with the number of layers of semiconductor material and insulating material used in ring resonator waveguide 207. The total charge may be given by:

Q=σ×S (Equation 3)

where Q is the total charge, σ is the surface charge density and S is the total surface area of all of the modulated charge regions 215 through which optical beam 215 is directed.

Thus, the modulation of free charge carriers in modulated charge regions 215 changes the index of refraction, which phase shifts optical beam 215 and thereby alters the optical path length and resonance condition of ring resonator waveguide 207. In one embodiment, signal 213 may be implemented to apply a voltage to bring ring resonator waveguide 207 into resonance with the λ_{R} wavelength of optical beam 215 In another embodiment, signal 213 may be implemented to apply a voltage to bring ring resonator waveguide 207 out of resonance with λ_{R} wavelength of optical beam 215.

It is appreciated that by modulating the free charge carriers in modulated charge regions 215, the resonance condition of ring resonator waveguide 207 is modulated very quickly in accordance with the teachings of the present invention. Therefore, optical switching structures based on embodiment in accordance with the teachings of the present invention are very fast, such as for example a high speed modulator having switching speeds on the order of greater than 2.5 Gbps. This compares favorably to slow switching ring resonators that are adjusted based on thermal effects. In addition, since embodiments of the present invention may be implemented using present day complementary metal oxide semiconductor (CMOS) compatible manufacturing techniques, embodiments of the present invention may be made substantially cheaper than other technologies as well as tightly integrated with driver electronics on the same die or chip. Furthermore, due to the design nature of embodiments of the present invention, optical devices of this nature can be at least two orders of magnitude smaller in size in comparison to present day optical modulator technologies, using for example arrayed waveguide grating (AWG) structures or the like.

It is appreciated that FIG. 2 illustrates an example according to embodiments of the present invention where a capacitor-type structure used to modulate free charge carriers in ring resonator waveguide 207. In other embodiments of the present invention, other structures may be used to modulate free charge carriers in ring resonator waveguide 207. For example, a reverse or forward biased PN diode structure included ring resonator waveguide 207 may be used to modulate free charge carriers to adjust the resonance condition. Other suitable embodiments may include injecting current and free charge carriers into ring resonator waveguide 207 through which optical beam 215 is directed.

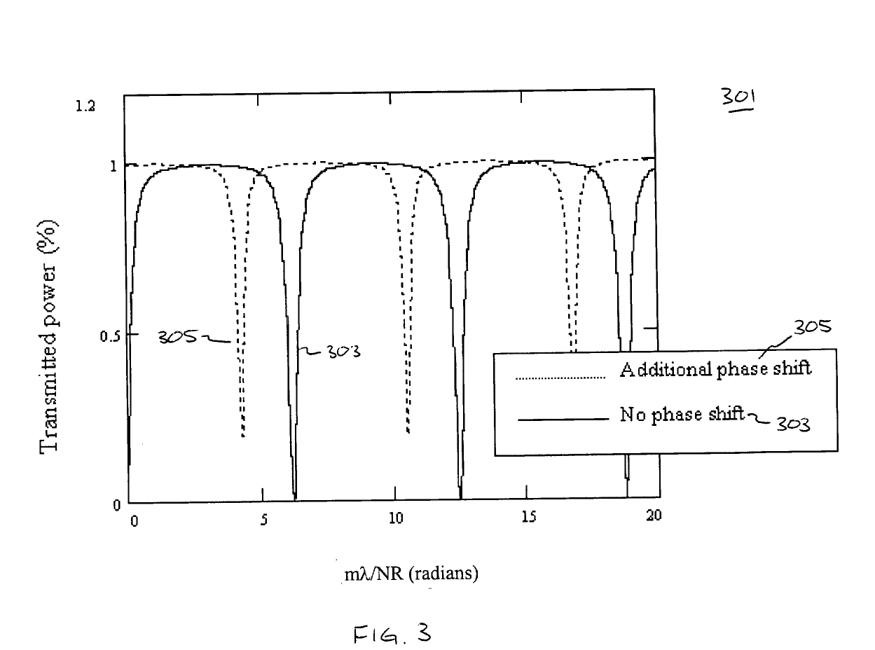

FIG. 3 is a diagram 301 illustrating the optical throughput or transmission power in relation to resonance condition or phase shift an optical beam through an the optical device in accordance with the teachings of the present invention. In one embodiment, diagram 301 illustrates an optical device according to optical device 101 of FIG. 1 or a ring resonator waveguide 207 according to FIG. 2. In particular, diagram 301 shows how the transmitted power for a particular wavelength λ_{R} changes as the resonance condition of the ring resonance changes. As shown, trace 303 shows that minimas in the transmitted power occur at approximately 6, 13 and 19 radians with no phase shift. However, with an additional phase shift according to an embodiment of an optical device, trace 305 shows that the minimas occur at approximately 4, 10 and 17 radians. Indeed, shifting the phase and changing resonance condition of the ring resonator waveguide by modulating free charge carriers in the modulated charge regions modulate an optical beam in accordance with the teachings of the present invention.

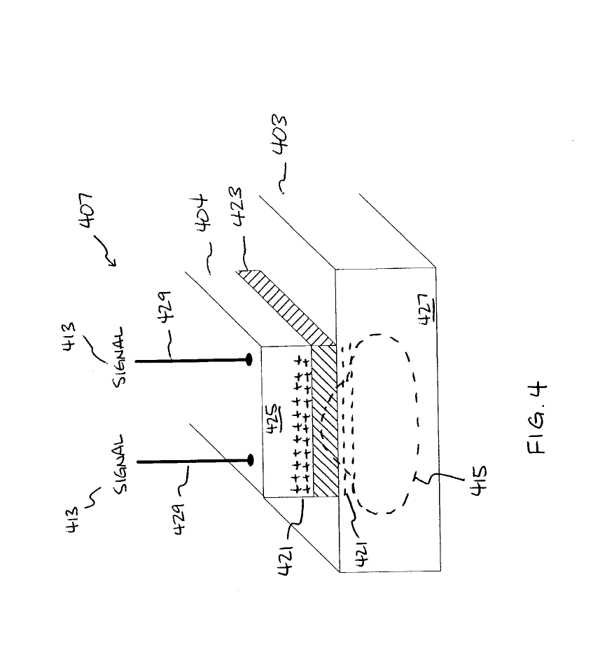

FIG. 4 is a cross-section illustration of another embodiment of a ring resonator waveguide 407 along dashed line A-A′ 111 in FIG. 1. It is appreciated that ring resonator waveguide 407 may also correspond to the embodiment of ring resonator waveguide 107 of FIG. 1 and may be used as an alternative embodiment to ring resonator waveguide 207 of FIG. 2. In the embodiment depicted in FIG. 4, ring resonator waveguide 407 is a rib waveguide including an insulator layer 423 disposed between two layers 403 and 404 of semiconductor material.

In the depicted embodiment, ring resonator waveguide 407 is similar to ring resonator waveguide 207 of FIG. 2 with the exception that insulator layer 423 is disposed in the rib region 425 instead of slab region 427 of ring resonator waveguide 407. A signal 413 is applied to semiconductor material layer 404 through conductors 429. As illustrated in FIG. 4, in one embodiment, conductors 429 are coupled to semiconductor material layer 404 in the “upper corners” of the rib region 425 of the rib waveguide outside the optical path of optical beam 415. Assuming that semiconductor material layer 404 includes p-type doping and that semiconductor material layer 403 includes n-type doping and that ring resonator waveguide 407 operates in accumulation mode, positive and negative charge carriers of modulated charge regions 421 are swept into regions proximate to insulator layer 423 as shown.

It is appreciated of course that the doping polarities and concentrations of the semiconductor material layers 403 and 404 can be modified or adjusted and/or that ring resonator waveguide 407 can operate in other modes (e.g. inversion or depletion) in accordance with the teachings of the present invention. In addition, it is appreciated that varying ranges of voltage values may be utilized for signal 413 across conductors 429 so as to realize modulated charge regions 421 proximate to insulator layer 423 in accordance with the teachings of the present invention.

In one embodiment, each of the semiconductor material layers 403 and 404 are biased in response to signal 413 voltages to modulate the concentration of free charge carriers in modulated charge regions 421. As shown in FIG. 4, optical beam 415 is directed through ring resonator waveguide 407 such that optical beam 415 is directed through the modulated charge regions 421. As a result of the modulated charge concentration in modulated charge regions 421, the phase of optical beam 415 is modulated in response to the modulated charge regions 421 and/or signal 413. Thus, the modulation of free charge carriers in modulated charge regions 415 changes the index of refraction, which phase shifts optical beam 415 and thereby alters the optical path length and resonance condition of ring resonator waveguide 407.

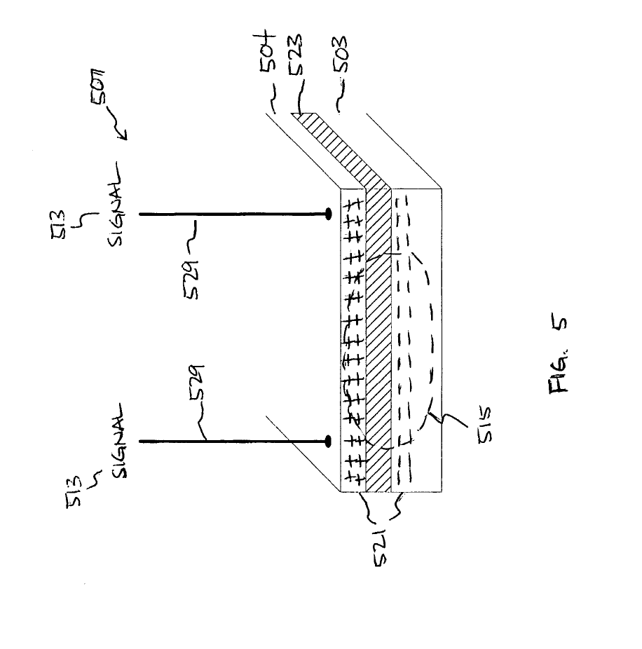

FIG. 5 is a cross-section illustration of yet another embodiment of a ring resonator waveguide 507 along dashed line A-A′ 111 in FIG. 1. It is appreciated that ring resonator waveguide 507 may also correspond to an embodiment of ring resonator waveguide 107 of FIG. 1 and may be used as an alternative embodiment to ring resonator waveguide 207 of FIG. 2 or to ring resonator waveguide 407 of FIG. 4. In the embodiment depicted in FIG. 5, ring resonator waveguide 507 is a waveguide including an insulator layer 523 disposed between two layers 503 and 504 of semiconductor material.

In the depicted embodiment, ring resonator waveguide 507 is similar to ring resonator waveguide 207 of FIG. 2 or ring resonator waveguide 407 of FIG. 4 with the exception that ring resonator waveguide 507 is strip waveguide instead of a rib waveguide. A signal 513 is applied to semiconductor material layer 504 through conductors 529. As illustrated in FIG. 5, in one embodiment, conductors 529 are coupled to semiconductor material layer 504 in the “upper corners” of the strip waveguide outside the optical path of optical beam 515. Assuming that semiconductor material layer 504 includes p-type doping and that semiconductor material layer 503 includes n-type doping and that ring resonator waveguide 507 operates in accumulation mode, positive and negative charge carriers of modulated charge regions 521 are swept into regions proximate to insulator layer 523 as shown.

It is appreciated of course that the doping polarities and concentrations of the semiconductor material layers 503 and 504 can be modified or adjusted and/or that ring resonator waveguide 507 can operate in other modes (e.g. inversion or depletion) in accordance with the teachings of the present invention. In addition, it is appreciated that varying ranges of voltage values may be utilized for signal 513 across conductors 529 so as to realize modulated charge regions 521 proximate to insulator layer 523 in accordance with the teachings of the present invention.

In one embodiment, each of the semiconductor material layers 503 and 504 are biased in response to signal 513 voltages to modulate the concentration of free charge carriers in modulated charge regions 521. As shown in FIG. 5, optical beam 515 is directed through ring resonator waveguide 507 such that optical beam 515 is directed through the modulated charge regions 521. As a result of the modulated charge concentration in modulated charge regions 521, the phase of optical beam 515 is modulated in response to the modulated charge regions 521 and/or signal 513. Thus, the modulation of free charge carriers in modulated charge regions 515 changes the index of refraction, which phase shifts optical beam 515 and thereby alters the optical path length and resonance condition of ring resonator waveguide 507.

It is noted that, for explanation purposes, the ring resonator waveguide embodiments have been described above with modulated charge regions that are modulated with “horizontal” structures. For instance, insulator layers 223, 423 and 523 are illustrated in FIGS. 2, 4 and 5 with a “horizontal” orientation relative to their respective waveguides. It is appreciated of course that in other embodiments, other structures may be employed to modulate charge in charge modulated regions in accordance with the teaching of the present invention. For example, in other embodiments, “vertical” type structures such as trench capacitor type structures may be disposed along a ring resonator to modulate charge in charge modulated regions to adjust the resonance condition of the ring resonators. In such an embodiment, a single long trench capacitor or a plurality of trench capacitor type structures may be disposed in the semiconductor material along the ring resonator in accordance with the teachings of the present invention.

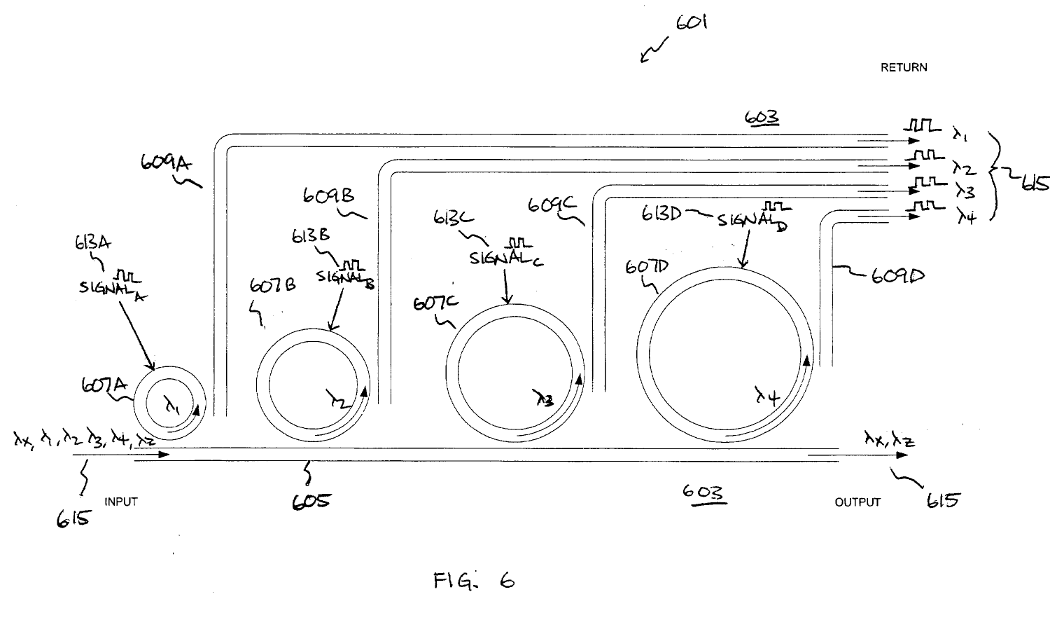

FIG. 6 is a diagram illustrating generally one embodiment of an optical device 601 including a plurality of ring resonators and a plurality of waveguides in semiconductor material in accordance with the teachings of the present invention. In one embodiment, optical device 601 includes a plurality of ring resonator waveguides 607A, 607B, 607C and 607D, each having respective resonance conditions, disposed in semiconductor material 603. It is appreciated that although optical device 601 has been illustrated in FIG. 6 with four ring resonator waveguides, optical device 601 may include a greater or fewer number of ring resonator waveguides may utilized in accordance with the teachings of the present invention.

As shown in the depicted embodiment, an input optical waveguide 605 is disposed in the semiconductor material 603 and is optically coupled to each of the plurality of ring resonator waveguides 607A, 607B, 607C and 607D. In one embodiment, each of the plurality of ring resonator waveguides 607A, 607B, 607C and 607D is designed to have a different resonant condition to receive a particular wavelength λ from optical waveguide 605. As also shown in the depicted embodiment, each of the plurality of ring resonator waveguides 607A, 607B, 607C and 607D is optically coupled to respective one of a plurality of output optical waveguides disposed in the semiconductor material 603. For instance, FIG. 6 shows that output optical waveguides 609A, 60B, 609C and 609D are is disposed in the semiconductor material 603 and are each optically coupled to a respective ring resonator waveguide 607A, 607B, 607C or 607D.

In one embodiment, a respective charge modulated region is modulated within each respective ring resonator waveguide 607A, 607B, 607C or 607D in response to a respective signal 613A, 613B, 613C or 613D, which results in the resonance conditions of in each respective ring resonator waveguide 607A, 607B, 607C or 607D being adjusted in response to signal 613A, 613B, 613C or 613D.

In one embodiment, ring resonator waveguide 607A is designed to be driven into or out of resonance with wavelength λ₁ in response to signal_{A}, ring resonator waveguide 607B is designed to be driven into or out of resonance with wavelength λ₂ in response to signal_{B}, ring resonator waveguide 607C is designed to be driven into or out of resonance with wavelength λ₃ in response to signal_{C} and ring resonator waveguide 607D is designed to be driven into or out of resonance with wavelength λ₄ in response to signal_{D}.

Operation according to one embodiment is as follows. An optical beam 615, including a plurality of wavelengths, such as for example λ₁, λ₂, λ₃ and λ₄, is directed into an input port of optical waveguide 605, which is illustrated at the bottom left of FIG. 6. It is appreciated that optical beam 615 may therefore be an optical communications beam for use in a WDM, DWDM system or the like in which each wavelength λ₁, λ₂, λ₃ and λ₄ corresponds to a separate channel. Optical beam 615 travels through optical waveguide 605 until it reaches ring resonator waveguide 607.

If the resonance condition of ring resonator waveguide 607A matches the wavelength λ₁, the λ₁ wavelength portion of optical beam 615 is evanescently coupled into ring resonator waveguide 607A. The remaining wavelengths or portions of optical beam 615 continue through optical waveguide 605. The λ₁ wavelength portion of optical beam 615 travels through ring resonator waveguide 607A and is evanescently coupled into waveguide 609A. The wavelength λ₁ portion of optical beam 615 then travels through waveguide 609A and out of the return port of waveguide 609A, which is illustrated at the top right of FIG. 6.

Similarly, if the resonance condition of ring resonator waveguide 607B matches the wavelength λ₂, the λ₂ wavelength portion of optical beam 615 is evanescently coupled into ring resonator waveguide 607B, which is then evanescently coupled into waveguide 609B and directed out of the return port of waveguide 609B. The same operation occurs for wavelengths λ₃ and λ₄. Any remaining wavelengths (e.g. λ_{X} and λ_{Y}) in optical beam 615 pass ring resonator waveguides 607A, 607B, 607C and 607D and are output from the output port of optical waveguide 603, which is illustrated at the bottom right of FIG. 6.

In one embodiment, signal_{A} 613A can therefore be used to independently modulate λ₁, signal_{B} 613B can therefore be used to independently modulate λ₂, signal_{C} 613C can therefore be used to independently modulate λ₃ and signal_{D} 613D can therefore be used to independently modulate λ₄. The modulated portions of optical beam 615 are then output at the return ports of 609A, 609B, 609C and 609D, which is illustrated at the top right corner of FIG. 6. In one embodiment, the return ports of output optical waveguides 609A, 60B, 609C and 609D can be optionally recombined or multiplexed back into a single waveguide to recombine the optical beams carried therein into a single optical beam.

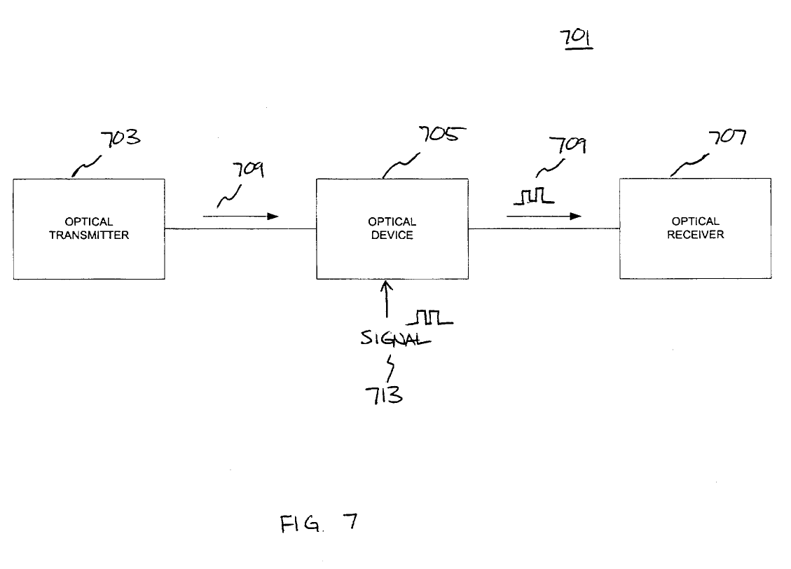

FIG. 7 is a block diagram illustration of one embodiment of a system including an optical transmitter and an optical receiver with an optical device according to embodiments of the present invention to modulate an optical beam directed from the optical transmitter to the optical receiver. In particular, FIG. 7 shows optical system 701 including an optical transmitter 703 and an optical receiver 707. In one embodiment, optical system 701 also includes an optical device 705 optically coupled between optical transmitter 703 and optical receiver 707. As shown in FIG. 7, optical transmitter 703 transmits an optical beam 709 that is received by optical device 705. In one embodiment, optical device 705 may include an optical modulator including a ring resonator having a resonance condition that is in accordance with the teachings of the present invention. For example, in one embodiment, optical device 705 may include any of the optical devices described above with respect to FIGS. 1-6 to modulate optical beam 709. As shown in the depicted embodiment, optical device 705 modulates optical beam 709 in response to signal 713. As shown in the depicted embodiment, modulated optical beam 709 is then directed from optical device 705 to optical receiver 707.

In the foregoing detailed description, the method and apparatus of the present invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

What is claimed is:

1. An apparatus, comprising:
a ring resonator having a resonance condition disposed in semiconductor material;
an input optical waveguide disposed in the semiconductor material optically coupled to the ring resonator;
a output optical waveguide disposed in the semiconductor material optically coupled to the ring resonator; and
a charge modulated region disposed in the ring resonator, the charge modulated region adapted to be modulated to adjust a resonance condition of the ring resonator.

2. The apparatus of claim 1 wherein a wavelength of an optical beam substantially matching the resonance condition of the ring resonator is directed from the input optical waveguide to the output optical waveguide through the ring resonator.

3. The apparatus of claim 1 wherein the charge modulated region is adapted to be modulated to adjust an index of refraction of the ring resonator.

4. The apparatus of claim 1 wherein the charge modulated region is adapted to be modulated to change a phase of an optical beam directed through the ring resonator.

5. The apparatus of claim 1 wherein the charge modulated region is adapted to be modulated to adjust an optical path length of the ring resonator

6. The apparatus of claim 1 wherein the ring resonator includes a variably capacitive structure to modulate the charge modulated region disposed in the ring resonator.

7. The apparatus of claim 6 wherein the variably capacitive structure includes an insulator disposed between the ring resonator and a conductive layer, the conductive layer coupled to receive a modulation signal, the charge modulated region adapted to be modulated in response to the modulation signal.

8. The apparatus of claim 7 wherein the conductive layer includes silicon.

9. The apparatus of claim 7 wherein the insulator includes an oxide material.

10. The apparatus of claim 1 wherein the ring resonator includes a PN diode disposed in the semiconductor material to modulate the charge modulated region disposed in the ring resonator.

11. The apparatus of claim 1 wherein the semiconductor material includes silicon.

12. The apparatus of claim 1 wherein the ring resonator is one of a plurality of ring resonators disposed in the semiconductor material, each of the plurality having a different resonant condition substantially matching a different wavelength of the optical beam directed through the input optical waveguide, each of the plurality of ring resonators optically coupled to the input optical waveguide.

13. The apparatus of claim 12 wherein the output optical waveguide is one of a plurality of output optical waveguides disposed in the semiconductor material, each of the plurality of ring resonators optically coupled to a corresponding one of the plurality of output optical waveguides.

14. The apparatus of claim 12 wherein each of the plurality of ring resonators include a corresponding one of a plurality of charge modulated regions, each of the plurality of charge modulated region adapted to be modulated to adjust the different resonance condition of each of the plurality of ring resonators.

15. The apparatus of claim 1 wherein the ring resonator is one of a plurality of ring resonators disposed in the semiconductor material optically coupled between the input and output optical waveguides.

16. The apparatus of claim 15 wherein resonance conditions of the plurality of ring resonators are adapted to be modulated to be substantially the same resonance condition such that a wavelength of an optical beam substantially matching the resonance condition of the plurality of ring resonators is directed from the input optical waveguide to the output optical waveguide through the plurality of ring resonators.

17. The apparatus of claim 16 wherein the wavelength of the optical beam substantially matching the resonance condition of the plurality of ring resonators is modulated in response to the modulated resonance conditions of the plurality of ring resonators.

18. A method, comprising:
directing an optical beam into a input optical waveguide disposed in a semiconductor material;
modulating a charge modulated region disposed in a ring resonator disposed in the semiconductor material proximate to the input optical waveguide to adjust a resonance condition of the ring resonator;
optically coupling the ring resonator to receive a wavelength of the optical beam substantially matching the resonance condition from the input optical waveguide; and
directing the wavelength of the optical beam substantially matching the resonance condition from the ring resonator to a output optical waveguide disposed in the semiconductor material proximate to the ring resonator, the wavelength of the optical beam modulated in response to the modulated charge region.

19. The method of claim 18 wherein modulating the charge modulated region comprises driving the charge modulated region into resonance with the wavelength of the optical beam with a modulation signal.

20. The method of claim 18 wherein modulating the charge modulated region comprises driving the charge modulated region out of resonance with the wavelength of the optical beam with a modulation signal.

21. The method of claim 18 wherein modulating the charge modulated region comprises modulating charge proximate to an insulator of a capacitive structure included in the ring resonator.

22. The method of claim 18 wherein modulating the charge modulated region comprises reverse biasing a PN diode disposed in the semiconductor material.

23. The method of claim 18 wherein modulating the charge modulated region disposed in the ring resonator includes modulating an index of refraction of the ring resonator.

24. The method of claim 18 wherein modulating the charge modulated region disposed in the ring resonator includes modulating phase of the wavelength of the optical beam in the ring resonator.

25. A system, comprising
an optical transmitter to transmit an optical beam; and
an optical device optically coupled to the optical transmitter to receive the optical beam, the optical device including
a input optical waveguide disposed in semiconductor material optically coupled to receive the optical beam;
a ring resonator having a resonance condition disposed in the semiconductor material, the ring resonator optically coupled to the input optical waveguide;
a output optical waveguide disposed in the semiconductor material optically coupled to the ring resonator; and
a charge modulated region disposed in the ring resonator, the charge modulated region adapted to be modulated to adjust a resonance condition of the ring resonator such that a wavelength of the optical beam substantially matching the resonance condition of the ring resonator is directed from the input optical waveguide to the output optical waveguide through the ring resonator.

26. The system of claim 25 further comprising an optical receiver optically coupled to the output optical waveguide to receive the wavelength of the optical beam substantially matching the resonance condition of the ring resonator, the wavelength of the optical beam modulated in response to the charge modulated region.

27. The system of claim 25 wherein the charge modulated region is adapted to be modulated to adjust an index of refraction of the ring resonator.

28. The system of claim 25 wherein the charge modulated region is adapted to be modulated to change a phase of the optical beam.

29. The system of claim 25 wherein the charge modulated region is adapted to be modulated to adjust an optical path length of the ring resonator

30. The system of claim 25 wherein the ring resonator includes a variably capacitive structure to modulate the charge modulated region disposed in the ring resonator.
